(19) United States
(12) Patent Application Publication
(10) Pub. No.: US 2025/0372597 A1
(43) Pub. Date: Dec. 4, 2025

(54) ELECTRODE SHEET MANUFACTURING DEVICE

(71) Applicant: Prime Planet Energy & Solutions, Inc., Tokyo (JP)

(72) Inventors: Yuuki TOYOSHIMA, Himeji-shi (JP); Joji SHITARA, Himeji-shi (JP); Hiroyoshi YAMAMOTO, Himeji-shi (JP); Hiroshi ICHISE, Himeji-shi (JP); Keisuke NAKAMURA, Himeji-shi (JP)

(21) Appl. No.: 19/206,047

(22) Filed: May 13, 2025

(30) Foreign Application Priority Data
May 28, 2024 (JP) 2024-086686

(51) Int. Cl. H01M 4/04

(52) U.S. Cl. CPC H01M 4/0435

(57) ABSTRACT

In an electrode sheet manufacturing device 1, a non-coated portion 12a (non-formed portion) of an electrode sheet 10 is stretched while being interposed between a support roll 61 and a press roll 62. The press roll 62 is a rubber roll including a rubber portion 62ab. A heat sink 64 is attached to the press roll 62.

### CROSS REFERENCE TO RELATED APPLICATIONS

The present application claims priority from Japanese Patent Application No. 2024-086686 filed on May 28, 2024, which is incorporated by reference herein in its entirety.

### BACKGROUND

The present disclosure relates to an electrode sheet manufacturing device.

Japanese Laid-open Patent Publication No. 2023-36089 discloses a manufacturing method for an electrode sheet including, on a metal foil, a coated portion that is coated with an active material layer including an electrode material and a non-coated portion is set in an end portion of the coated portion. In the manufacturing method disclosed in Japanese Laid-open Patent Publication No. 2023-36089, it is disclosed that the non-coated portion is pressed with a pair of elastic rolls (rubber rolls). A compression force and a deformation force can be applied to the same portion of the non-coated portion by pressing the non-coated portion using the pair of elastic rolls. Thus, the non-coated portion can be stretched while a break of the non-coated portion is suppressed.

Incidentally, the present inventor intends to reduce variation in stretching of the non-coated portion (non-formed portion).

### SUMMARY

An electrode sheet manufacturing device disclosed herein is a manufacturing device that manufactures an electrode sheet including a current collector formed of a long metal foil, a non-formed portion set in a preset position in the current collector in the width direction so as to extend in the length direction, and an electrode active material layer formed in a portion of the current collector excluding the non-formed portion, and includes a conveyance device that conveys the electrode sheet along a preset conveyance path, a support roll that is arranged on the conveyance path and supports a first surface of the electrode sheet that is conveyed along the conveyance path in the width direction, a press roll arranged so as to be opposed to the support roll on a second surface of the electrode sheet, a driving device that presses the press roll to the support roll with the electrode sheet interposed therebetween, and a heat sink. The press roll is arranged such that the non-formed portion of the electrode sheet is interposed between the support roll and the press roll. The press roll is a rubber roll at least an outer peripheral surface of which is formed of rubber. The heat sink is attached to an end portion of the press roll in a shaft direction.

According to the electrode sheet manufacturing device, variation in stretching of the non-formed portion in which the electrode sheet is not formed can be reduced.

### BRIEF DESCRIPTION OF THE DRAWINGS

FIG. 1 is a flowchart of manufacturing performed by an electrode sheet manufacturing device 1.

FIG. 2 is a schematic view of an electrode sheet 10.

FIG. 3 is a schematic side view of the electrode sheet manufacturing device 1.

FIG. 4 is a front view of a roll press machine 60.

FIG. 5 is a cross-sectional view illustrating a cross section taken along the line A-A in FIG. 4.

FIG. 6A and FIG. 6B are views illustrating modified examples of a heat sink.

### DETAILED DESCRIPTION

Preferred embodiments of a technology disclosed herein will be described below with reference to the accompanying drawings. As a matter of course, the preferred embodiments described herein are not intended to be particularly limiting the present disclosure. The accompanying drawings are schematic and do not necessarily reflect actual members or portions. Members/portions that have the same effect will be denoted by the same sign as appropriate, and the overlapping description will be omitted as appropriate.

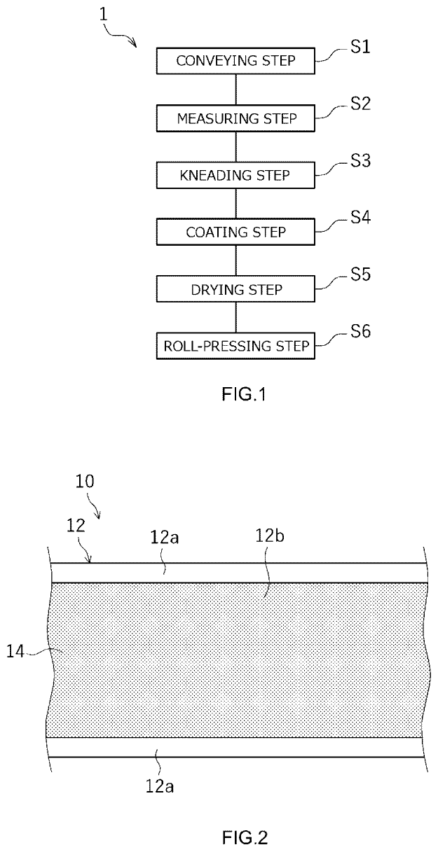

FIG. 1 is a flowchart of manufacturing performed by an electrode sheet manufacturing device 1. As illustrated in FIG. 1, manufacturing performed by the electrode sheet manufacturing device 1 includes a conveying step S1, a measuring step S2, a kneading step S3, a coating step S4, a drying step S5, and a roll-pressing step S6. However, the manufacturing performed by the electrode sheet manufacturing device 1 may include some other step.

### <Electrode Sheet Manufacturing Device 1>

The electrode sheet manufacturing device 1 manufactures an electrode sheet 10 (see FIG. 2) that forms an electricity storage device. The electrode sheet 10 forms a positive electrode sheet or a negative electrode sheet of an electrode body that is stored in the electricity storage device. The term “electricity storage device” refers to a device that can be charged and discharged repeatedly, and expresses a concept encompassing so-called storage batteries (that is, chemical batteries), such as lithium-ion secondary batteries, nickel-hydrogen batteries, nickel-cadmium batteries, or the like, as well as capacitors (that is, physical batteries), such as electrical double-layer capacitors or the like. As an example, along with a configuration of the electrode sheet 10 used for a lithium-ion secondary battery, the electrode sheet manufacturing device 1 that manufactures the electrode sheet 10 will be described below.

### <Electrode Sheet 10>

FIG. 2 is a schematic view of the electrode sheet 10. As illustrated in FIG. 2, the electrode sheet 10 includes a current collector 12 and an electrode active material layer 14. The current collector 12 is a member formed of a long metal foil. The current collector 12 is a band-like metal member. As the current collector 12, a metal material having a desired conductivity can be used. As a positive electrode current collecting foil, for example, aluminum, an aluminum alloy, or the like can be used. As a negative electrode current collecting foil, for example, copper, a copper alloy, or the like can be used. A portion of the current collector 12 in a preset position is coated with the electrode active material layer 14. The electrode active material layer 14 is formed at least on one surface of the band-like current collector 12. In this preferred embodiment, the electrode active material layer 14 is formed on both surfaces of the current collector 12. The electrode active material layer 14 is a layer including an electrode active material. As a positive electrode active material, for example, a lithium transition metal composite material can be used. As a negative electrode active material, for example, a carbon material, a silicon-based material, mixed oxides thereof, or the like can be used. The electrode active material layer may include an additive, such as a binder, a conductive material, or the like, other than the electrode active material.

The electrode sheet 10 is formed by applying an electrode mixture slurry that is to be the electrode active material layer 14 to the current collector 12 and drying the applied electrode mixture slurry. A non-coated portion 12a and a coated portion 12b are set in the current collector 12. The non-coated portion 12a is a portion of the current collector 12 that is not coated with the electrode active material layer 14. The non-coated portion 12a is set in a preset position in the current collector 12 in a width direction so as to extend in a length direction. In this preferred embodiment, the non-coated portion 12a is set at each of both ends of the electrode sheet 10 in the width direction. The non-coated portion 12a is one example of a non-formed portion set in a preset position in the current collector 12 in the width direction so as to extend in the length direction, as a portion in which the electrode active material layer 14 is not formed. The electrode active material layer 14 is formed in a portion of the current collector 12 excluding the non-coated portion 12a. Herein, the electrode active material layer 14 is formed such that the portion of the current collector 12 excluding the non-coated portion 12a is coated with the electrode active material layer 14. The coated portion 12b is arranged between the non-coated portions 12a arranged at the both ends of the electrode sheet 10. The electrode mixture slurry is applied to the coated portion 12b. Thus, the electrode active material layer 14 is formed on the coated portion 12b of the current collector 12. That is, the electrode active material layer 14 is arranged between the non-coated portions 12a arranged at the both ends of the electrode sheet 10 in the width direction.

### <Conveyance Device 15>

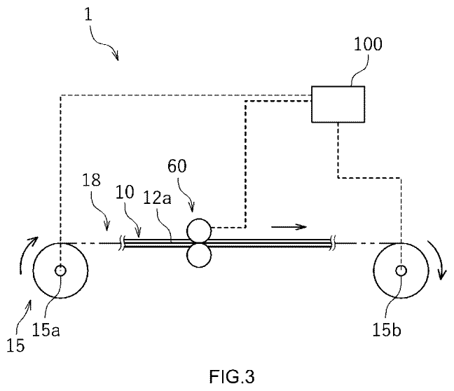

In the conveying step S1 illustrated in FIG. 1, the electrode sheet 10 is conveyed. FIG. 3 is a schematic side view of the electrode sheet manufacturing device 1. The conveying step S1 can be realized by a conveyance device 15. The conveyance device 15 conveys the electrode sheet 10. For example, a motor is used for the conveyance device 15. The conveyance device 15 includes an unwinding roll 15a and a winding roll 15b so as to convey the electrode sheet 10 at a preset conveyance speed. The unwinding roll 15a is arranged upstream of the roll press machine 60 in a conveyance direction. The winding roll 15b is arranged downstream of the roll press machine 60 in the conveyance direction. However, the conveyance device 15 is not limited to a configuration with the unwinding roll 15a and the winding roll 15b. For example, the conveyance device 15 may include some other roll than the unwinding roll 15a and the winding roll 15b. The electrode sheet 10 is conveyed along a preset conveyance path 18 by the conveyance device 15.

### <Measuring Step S2, Kneading Step S3, Coating Step S4, and Drying Step S5>

In the measuring step S2 illustrated in FIG. 1, raw materials of the electrode active material layer 14 (see FIG. 2) are measured. The measuring can be realized, for example, by a measuring device (not illustrated) including a balance, a load cell, or the like. The measured raw materials of the electrode active material layer 14 are mixed in the kneading step S3. The kneading step S3 can be realized by a kneading device (not illustrated). The materials of the electrode active material layer 14 that have been made into a slurry state by the kneading device are applied to the current collector 12 (see FIG. 2) in the coating step S4. The coating step S4 can be realized by, for example, a coating device (not illustrated), such as a slit coater, a gravure coater, a die coater, a comma coater, or the like. In the drying step S5, the applied row material of the electrode active material layer 14 in a slurry state is dried. The drying step S5 can be realized by, for example, a drying device (not illustrated) that emits a hot air, an infrared ray.

### <Roll-Pressing Step S6>

In the roll-pressing step S6, the electrode sheet 10 is pressed. The roll-pressing step S6 can be realized by the roll press machine 60 illustrated in FIG. 3. As illustrated in FIG. 3, the electrode sheet 10 is pressed by the roll press machine 60 in middle of the conveyance path 18. The electrode sheet 10 is supplied by the unwinding roll 15a. The electrode sheet 10 pressed by the roll press machine 60 is wound by the winding roll 15b. The electrode sheet manufacturing device 1 includes a control device 100 that controls the unwinding roll 15a, the winding roll 15b, and the roll press machine 60.

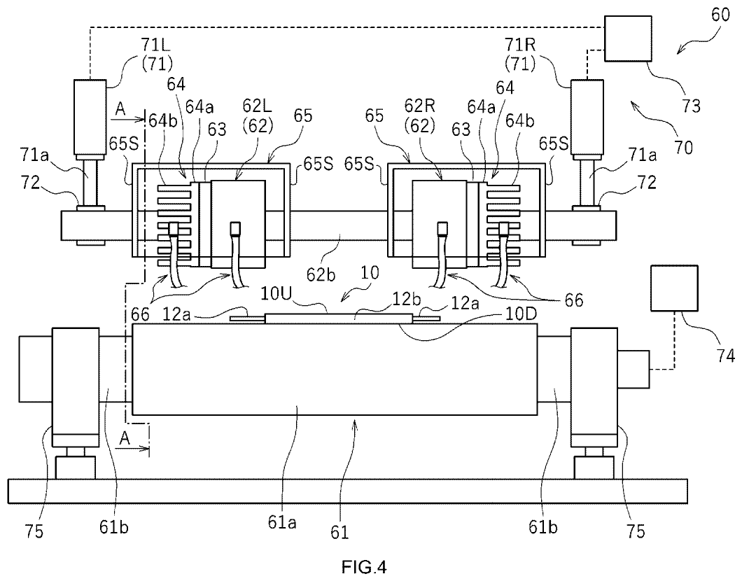

FIG. 4 is a front view of the roll press machine 60. Herein, the roll press machine 60 according to this preferred embodiment is a device that presses the non-coated portion 12a of the electrode sheet 10 by rubber rolls before or after pressing the coated portion 12b. When the non-coated portion 12a is pressed by the rubber rolls, the non-coated portion 12a receives reaction forces of elastic deformation and compressive deformation of the rubber rolls, and a portion thereof pushed by the rolls is pressed and is also pulled. As a result, the non-coated portion 12a can be stretched while a break of the non-coated portion 12a is suppressed. Because of a function described above, the device that presses the non-coated portion 12a of the electrode sheet 10 by the rubber rolls can be referred to as an elasticity powered stretching (EPS) device as appropriate. Note that the electrode sheet manufacturing device 1 may include, in addition to the roll press machine 60, a device that presses the coated portion 12b of the electrode sheet 10.

As illustrated in FIG. 4, the roll press machine 60 includes a support roll 61, a press roll 62, a heat conduction sheet 63, a heat sink 64, a cover 65, an air blowing device 66, a suction device 67 (see FIG. 4), and a press pressure regulating mechanism 70.

### <Support Roll 61>

The support roll 61 is arranged on the conveyance path 18 (see FIG. 3). The support roll 61 supports a first surface 10D of the electrode sheet 10 that is conveyed along the conveyance path 18 in the width direction of the electrode sheet 10. In this preferred embodiment, the electrode sheet 10 includes the first surface 10D and a second surface 10U. Herein, the first surface 10D forms a lower surface of the electrode sheet 10. The second surface 10U is a surface of the electrode sheet 10 at an opposite side to the first surface 10D. Herein, the second surface 10U forms an upper surface of the electrode sheet 10. The support roll 61 is arranged under the press roll 62. The support roll 61 is a rubber roll that presses the non-coated portion 12a of the electrode sheet 10 with the press roll 62. The support roll 61 is one example of rubber role in the present disclosure. In this preferred embodiment, the support roll 61 includes a body portion 61a and both shaft portions 61b.

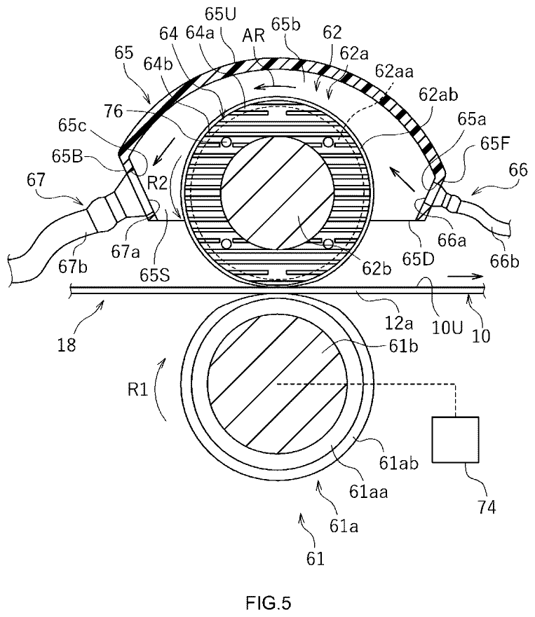

FIG. 5 is a cross-sectional view of a cross section taken along the line A-A of FIG. 4. Note that, in FIG. 5, a state when the non-coated portion 12a is pressed by the support roll 61 and the press roll 62 is illustrated. As illustrated in FIG. 5, the body portion 61a includes a shaft portion 61aa and a rubber portion 61ab. The shaft portion 61aa is made of metal. Although there is no particular limitation on a material that forms the shaft portion 61aa, for example, the material that forms the shaft portion 61aa is a material having a relatively high hardness, such as SUS304 (stainless steel). The rubber portion 61ab is arranged so as to cover at least an outer peripheral surface of the shaft portion 61aa. A material that forms the rubber portion 61ab is, for example, nitrile rubber (NBR). The support roll 61 presses the non-coated portion 12a of the electrode sheet 10 by the rubber portion 61ab.

The support roll 61 is rotated in a predetermined direction by a roll driving device 74 (see FIG. 4) that will be described later. In this preferred embodiment, the support roll 61 rotates in a direction of an arrow R1 illustrated in FIG. 5. At this time, the electrode sheet 10 is conveyed from left to right as sheen in FIG. 5. That is, left in FIG. 5 is an upstream side in the conveyance direction, and right in the FIG. 5 is a downstream side in the conveyance direction.

As illustrated in FIG. 4, the both shaft portions 61b are inserted in the body portion 61a. The both shaft portions 61b are inserted in the shaft portion 61aa of the body portion 61a (see FIG. 5). The both shaft portions 61b extend such that each of the both shaft portions 61b reaches outside of the support roll 61 in a shaft direction. Note that, although not illustrated, a bearing, a gap screw that adjusts a gap between the support roll 61 and the press roll 62, or the like are attached to the both shaft portions 61b.

### <Press Roll 62>

As illustrated in FIG. 5, the press roll 62 is arranged so as to be opposed to the support roll 61 on the second surface 10U (herein, an upper surface) of the electrode sheet 10. The press roll 62 is arranged such that the non-coated portion 12a is interposed between the press roll 62 and the support roll 61, except the coated portion 12b of the electrode sheet 10 (see FIG. 2). Herein, a center position of the press roll 62 in the shaft direction and a center position of the support roll 61 in the shaft direction are arranged to be aligned in an up-down direction. As illustrated in FIG. 4, the press roll 62 is a roll that presses the non-coated portion 12a of the electrode sheet 10 with the support roll 61. The press roll 62 is one example of a rubber roll. In this preferred embodiment, a roll at least an outer peripheral surface of which is formed of rubber is a rubber roll. The press roll 62 is not arranged over the coated portion 12b of the electrode sheet 10 (see FIG. 2). In this preferred embodiment, as illustrated above, the non-coated portion 12a of the electrode sheet 10 is set each of the both ends of the electrode sheet 10 in the width direction. Therefore, as illustrated in FIG. 4, the press roll 62 is arranged over each of the non-coated portions 12a arranged at the both ends of the electrode sheet 10 in the width direction. The number of the press roll 62 is two. However, the number of the non-coated portions 12a may be one. In a case where the number of the non-coated portions 12a is one, the number of the press rolls 62 may be one. One of the two press rolls 62 that is arranged at left is also referred to as a press roll 62L, and the other one of the two press rolls 62 that is arranged at right is also referred to as a press roll 62R. However, in description that applies to each of the press rolls 62L and 62R, the name of the press roll 62 is used as appropriate. The press roll 62 (herein, the press rolls 62L and 62R) can be replaced and can be detached from the roll press machine 60. In this preferred embodiment, the press roll 62 includes a body portion 62a and both shaft portions 62b.

As illustrated in FIG. 5, the body portion 62a includes a shaft portion 62aa and a rubber portion 62ab. The shaft portion 62aa is made of metal. Although there is no particular limitation on a material that forms the shaft portion 62aa, for example, the material that forms the shaft portion 62aa is a material having a relatively high hardness, such as SUS304 (stainless steel). The rubber portion 62ab is arranged so as to cover at least an outer peripheral surface of the shaft portion 62aa. Although there is no particular limitation on a material that forms the rubber portion 62ab, for example, the material that forms the rubber portion 62ab is nitrile rubber (NBR). The rubber portion 62ab is one example of rubber in the present disclosure. The press roll 62 presses the non-coated portion 12a of the electrode sheet 10 by the rubber portion 62ab.

As illustrated in FIG. 4, the both shaft portions 62b are inserted in the body portion 62a. The both shaft portions 62b are inserted in the shaft portion 62aa of the body portion 62a (see FIG. 5). The both shaft portions 62b extend such that each of the both shaft portions 62b reaches outside of a corresponding one of the two support rolls 62 in the shaft direction. Note that, although not illustrated, a bearing, a gap screw that adjusts a gap between the support roll 61 and the press roll 62, or the like may be attached to the both shaft portions 62b.

As illustrated in FIG. 5, the electrode sheet 10 is interposed between the support roll 61 and the press roll 62 and, when the support roll 61 rotates in the direction of the arrow R1, the press roll 62 receives a force that rotates in a direction of an arrow R2 via the electrode sheet 10. Alternatively, when the electrode sheet 10 is not arranged and the support roll 61 and the press roll 62 contact each other, the press roll 62 receives a force that rotates in the direction of the arrow R2 due to a rotating force of the support roll 61. Thus, the press roll 62 rotates in the direction of the arrow R2. That is, the press roll 62 is a driven roll that rotates following rotation of the support roll 61.

### <Heat Conduction Sheet 63>

As illustrated in FIG. 4, the heat conduction sheet 63 is arranged between the press roll 62 and the heat sink 64. In this preferred embodiment, the heat conduction sheet 63 has a circular shape when viewed from a shaft direction of the press roll 62. The heat conduction sheet 63 is formed such that an outer diameter of the heat conduction sheet 63 is slightly smaller than that of the press roll 62. Therefore, when the support roll 61 and the press roll 62 press the electrode sheet 10, the heat conduction sheet 63 does not contact the support roll 61. However, the shape of the heat conduction sheet 63 is not limited thereto. The heat conduction sheet 63 is fixed to the press roll 62 together with the heat sink 64 by screws 76 illustrated in FIG. 5. Although there is no particular limitation on a material that forms the heat conduction sheet 63, for example, the heat conduction sheet 63 is formed of a resin material, such as acrylic, silicon, polypropylene (PP), polyphenylene sulfide (PPS), or the like.

### <Heat Sink 64>

As illustrated in FIG. 4, the heat sink 64 is attached to an end portion of a corresponding one of the press rolls 62 in the shaft direction. In this preferred embodiment, the heat sink 64 is attached to each of the press rolls 62L and the 62R. The heat sink 64 attached to an outer side of the press roll 62L and the heat sink 64 attached to an outer side of the press roll 62R are arranged laterally symmetrical in the width direction of the electrode sheet 10. As illustrated in FIG. 5, the heat sink 64 is attached to the shaft portion 62aa and the rubber portion 62ab of the press roll 62. In this preferred embodiment, the heat sink 64 is attached to the press roll 62 via the heat conduction sheet 63. Although there is no particular limitation on a material of the heat sink 64, for example, the heat sink 64 is formed of aluminum, an aluminum alloy, stainless steel, or the like. The material that forms the heat sink 64 is preferably a material having a relatively high thermal conductivity. As illustrated in FIG. 4, the heat sink 64 includes a base portion 64a and a raised portion 64b.

The base portion 64a is positioned inside the heat sink 64 in the width direction of the electrode sheet 10. As illustrated in FIG. 5, the base portion 64a has a circular shape when viewed from the shaft direction of the press roll 62. In this preferred embodiment, the base portion 64a has approximately the same as that of the heat conduction sheet 63 (see FIG. 4). That is, an outer diameter of the base portion 64a is slightly smaller than an outer diameter of the press roll 62. The screws 76 are attached to the base portion 64a. Thus, the heat sink 64 is attached to the press roll 62.

The raised portion 64b has a plate-like shape that extends outward from the base portion 64a in the width direction of the electrode sheet 10. As illustrated in FIG. 5, when viewed from the shaft direction of the press roll 62, as the raised portion 64b, multiple plate-like members that extend in one direction are provided. In this preferred embodiment, the multiple raised portions 64b are appropriately in parallel to each other, when viewed from the shaft direction of the press roll 62. Note that the base portion 64a and the raised portion 64b may be integrally formed, and may be as separate bodies. The shape of the raised portion 64b is not limited thereto.

### <Cover 65>

The cover 65 is arranged so as to cover a portion of the heat sink 64 and a portion of the press roll 62. In this preferred embodiment, about upper half of each of the heat sink 64 and the press roll 62 is covered with the cover 65. As illustrated in FIG. 4, in this preferred embodiment, the covers 65 are arranged such that each of the covers 65 covers a corresponding one of the two press rolls 62. Although there is no particular limitation on a material that forms the cover 65, for example, the cover 65 is formed of acrylic. In this preferred embodiment, as illustrated in FIG. 5, the cover 65 includes a front wall 65F, an upper wall 65U, a rear wall 65B, a lower wall 65D, and a side wall 65S (see also FIG. 4). The front wall 65F is arranged downstream of the press roll 62 in the conveyance direction of the electrode sheet 10. The upper wall 65U is arranged over the press roll 62. The upper wall 65U extends in a circumferential direction of the press roll 62. The rear wall 65B is arranged upstream of the press roll 62 in the conveyance direction of the electrode sheet 10. The front wall 65F and the rear wall 65B extend in a direction approaching to the press roll 62 as proceeding downward. The lower wall 65D is connected to lower ends of the front wall 65F, the rear wall 65B, and the side wall 65S. Although not illustrated, a range that is slightly larger than a portion of the lower wall 65D that overlaps with the press roll 62 when viewed from top is hallowed out. Therefore, the press roll 62 does not contact the lower wall 65D. A position of a lower end of the press roll 62 is below the lower wall 65D. The side wall 65S is connected to both end portions of each of the front wall 65F, the upper wall 65U, the lower wall 65D, and the rear wall 65B. The side wall 65S has an approximately fan shape. Although not illustrated, the side wall 65S is fixed to the both shaft portions 62b, so that the cover 65 is fixed. However, there is no particular limitation on a method for fixing the cover 65. As illustrated in FIG. 5, the cover 65 includes an inflow port 65a, an air passage 65b, an outflow port 65c.

The inflow port 65a is formed in the front wall 65F. The inflow port 65a is opened toward the heat sink 64. Although there is no particular limitation on a shape of the inflow port 65a, for example, the inflow port 65a has a circular shape. The air blowing device 66 that will be described later is connected to the inflow port 65a. As illustrated in FIG. 4, in this preferred embodiment, two air blowing devices 66 are connected to one cover 65. Therefore, two inflow ports 65a are formed for one cover 65. However, there is no particular limitation on the number of the inflow ports 65a.

As illustrated in FIG. 5, the air passage 65b is connected to the inflow port 65a. The air passage 65b is a flow passage formed by the front wall 65F, the upper wall 65U, the rear wall 65B, the lower wall 65D, and the side wall 65S. Therefore, the air passage 65b extends in the circumferential direction of the press roll 62. Air that has flowed in from the inflow port 65a passes through the air passage 65b toward the outflow port 65c.

The outflow port 65c is connected to the air passage 65b and is opened downstream of the inflow port 65a in a predetermined rotation direction of the press roll 62. In this preferred embodiment, the outflow port 65c is formed in the rear wall 65B. In this preferred embodiment, the press roll 62 rotates in the direction of the arrow R2 illustrated in FIG. 5. Therefore, the rear wall 65B is positioned downstream of the press roll 62 in the rotation direction. Although there is no particular limitation on a shape of the outflow port 65c, for example, the outflow port 65c has a rectangular shape. The suction device 67 that will be described later is connected to the outflow port 65c.

The air blowing device 66 is attached to the inflow port 65a. In this preferred embodiment, as illustrated in FIG. 4, two air blowing devices 66 are attached to one cover 65. The air blowing device 66 is a device that blows air to the heat sink 64. As illustrated in FIG. 5, the air blowing device 66 includes an air blowing port 66a and a passage portion 66b. The air blowing port 66a is opposed to the heat sink 64. The passage portion 66b is configured of, for example, a pressure resistant hose, a connector connected to a pressure resistant hose, or the like. The air blowing port 66a is positioned at one end of the passage portion 66b. The other end of the passage portion 66b is connected, for example, to a compressor (not illustrated). When the compressor is driven, compressed air passes through the passage portion 66b and the air is sent to the air passage 65b from the air blowing port 66a.

The suction device 67 is attached to the outflow port 65c. The suction device 67 is a device that sucks air inside the cover 65. The suction device 67 includes a suction port 67a and a passage portion 67b. The suction port 67a faces toward inside of the cover 65. The passage portion 67b is configured of, for example, a pressure resistant hose, a connector connected to a pressure resistant hose, or the like. The suction port 67a is positioned at one end of the passage portion 67b. For example, a vacuum pump (not illustrated) is connected to the other end of the passage portion 67b. When the vacuum pump is driven, air inside the cover 65 is sucked from the suction port 67a, passes through the passage portion 67b, and flows out of the cover 65. In this preferred embodiment, an air suction amount of the suction device 67 is set to be larger than an air blowing amount of the air blowing device 66. For example, a rotation amount of each of the compressor and the vacuum pump or the like is set such that a suction amount of the vacuum pump of the suction device 67 is larger than an air blowing amount of the compressor of the air blowing device 66.

As illustrated in FIG. 4, the press pressure regulating mechanism 70 includes a press cylinder 71, a roll chock 72, a cylinder driving device 73, the roll driving device 74, and a supporting portion 75.

The press cylinder 71 presses the press roll 62 to the support roll 61. One press cylinder 71 is arranged on a more outer side than each of both ends of the press roll 62. Herein, in FIG. 4, the press cylinder 71 arranged at left of the electrode sheet 10 is also referred to as a press cylinder 71L and the press cylinder 71 arranged at right of the electrode sheet 10 is also referred to as a press cylinder 71R. However, in a case where a common item for the press cylinders 71L and 71R is described, the press cylinders 71L and R are referred to as the press cylinders 71. In this preferred embodiment, the press cylinder 71 is a pneumatic cylinder. The press cylinder 71 includes a rod 71a. The rod 71a is connected to the roll chock 72. The roll chock 72 is a member that rotatably supports the both shaft portions 62b of the press roll 62. When the press cylinder 71 is driven and the rod 71a is lowered, the press roll 62 is lowered. When the press cylinder 71 is driven and the rod 71a is lifted, the press roll 62 is lifted.

The cylinder driving device 73 is a device that presses the press roll 62 to the support roll 61 with the electrode sheet 10 interposed between the press roll 62 and the support roll 61. The cylinder driving device 73 is one example of a driving device according to the present disclosure. The cylinder driving device 73 is connected to the press cylinder 71. The cylinder driving device 73 drives the press cylinder 71. Thus, the rod 71a of the press cylinder 71 is lifted and lowered. In this preferred embodiment, the cylinder driving device 73 is configured to independently drive each of the press cylinder 71L and the press cylinder 71R. That is, the cylinder driving device 73 independently drives each of the press rolls 62 arranged over a corresponding one of the non-coated portion 12a arranged at the both ends of the electrode sheet 10 in the width direction. The cylinder driving device 73 is connected to the control device 100 (see FIG. 3).

The roll driving device 74 is connected to the support roll 61. The roll driving device 74 is a device that rotates the support roll 61. In this preferred embodiment, the roll driving device 74 rotates the support roll 61 in the direction of the arrow R1 illustrated in FIG. 5. Although there is no particular limitation on a configuration of the roll driving device 74, for example, the roll driving device 74 is configured of an electric motor, a gear, or the like. The roll driving device 74 is connected to the control device 100 (see FIG. 3). Note that the roll driving device 74 may be a device that rotates the press roll 62.

The supporting portion 75 is a member that supports the support roll 61. The supporting portion 75 supports the both shaft portions 61b of the support roll 61.

The control device 100 illustrated in FIG. 3 controls the roll press machine 60. There is no particular limitation on a configuration of the control device 100. The control device 100 is, for example, a microcomputer. Although there is no particular limitation on a configuration of a hardware of the microcomputer, for example, the microcomputer includes an I/F, a CPU, a ROM, a RAM, and a storage device.

The electrode sheet manufacturing device 1 according to this preferred embodiment has been described above. Next, an operation performed when the non-coated portion 12a of the electrode sheet 10 is pressed by the roll press machine 60 will be described.

First, the cylinder driving device 73 and the roll driving device 74 illustrated in FIG. 4 are controlled by the control device 100. The cylinder driving device 73 lowers the rod 71a of the press cylinder 71. The cylinder driving device 73 lowers the rod 71a to a preset position. Thus, the press roll 62 is lowered. At this time, the roll driving device 74 rotates the support roll 61. In this preferred embodiment, as illustrated in FIG. 5, the roll driving device 74 rotates the support roll 61 in the direction of the arrow R1. When the press roll 62 is lowered, a portion of the non-coated portion 12a interposed between the support roll 61 and the press roll 62 is compressed.

As illustrated in FIG. 5, in vicinity of the non-coated portion 12a, the rubber portion 61ab of the support roll 61 and the rubber portion 62ab of the press roll 62 are compressively deformed. When the support roll 61 and the press roll 62 rotate, each of compressed portions of the rubber portions 61ab and 62ab returns to an original shape due to elasticity. Thus, portions of the rubber portions 61ab and 62ab that have moved to the vicinity of the non-coated portion 12a are compressed. Therefore, when the support roll 61 and the press roll 62 rotate and the electrode sheet 10 is conveyed, each of the rubber portions 61ab and 62ab is elastically deformed in a radial direction of a corresponding one of the support roll 61 and the press roll 62 in vicinity of the non-coated portion 12a. The elastic deformation is repeated in a circumferential direction of each of the support roll 61 and the press roll 62. The rubber portions 61ab and 62ab generates heat by repeating the elastic deformation.

The heat conduction sheet 63 and the heat sink 64 are attached to the press roll 62. Therefore, heat generated by the press roll 62 is transferred to the heat sink 64 via the heat conduction sheet 63. When the press roll 62 rotates, the heat sink 64 attached to the press roll 62 also rotates. At this time, the heat sink 64 contacts air AR inside the cover 65. At this time, a part of heat of the heat sink 64 is emitted to air AR.

The control device 100 (see FIG. 3) controls the air blowing device 66 and the suction device 67. The control device 100 sets the air suction amount of the suction device 67 and the air blowing amount of the air blowing device 66 such that the air suction amount of the suction device 67 is larger than the air blowing amount of the air blowing device 66, as described above. At this time, the air sent to inside of the cover 65 from the air blowing port 66a of the air blowing device 66 passes through the air passage 65b and is sucked from the suction port 67a. Therefore, the air AR inside the cover 65 passes through the air passage 65b from the inflow port 65a and forms a flow in a direction toward the outflow port 65c. When the air AR passes through the air passage 65b, the air AR contacts the heat sink 64. At this time, the heat of the heat sink 64 is emitted to the air AR. The air AR to which the heat is emitted from the heat sink 64 is sucked from the suction port 67a of the suction device 67. Therefore, the heat generated by the press roll 62 is discharged to outside of the roll press machine 60 via the suction device 67.

Incidentally, according to a finding of the present inventor, an extension coefficient of the non-coated portion of the electrode sheet changes depending on a temperature of the press roll (rubber roll) that presses the current collector. That is, the higher the temperature of the press roll is, the larger the extension coefficient of the non-coated portion becomes. On the other hand, when the press roll stretches the non-coated portion, the press roll is elastically deformed. Therefore, when the press roll stretches the electrode sheet, the press roll generates heat, and a surface temperature of the press roll rises. When the press roll stretches the non-coated portion, the surface temperature of the press roll rises, and thus, the extension coefficient of the non-coated portion is likely to be uneven.

According to the electrode sheet manufacturing device 1 of this preferred embodiment, the electrode sheet 10 is conveyed along the conveyance path 18. The press roll 62 is pressed to the support roll 61 with the non-coated portion 12a of the electrode sheet 10 interposed therebetween by the cylinder driving device 73 of the roll press machine 60. The press roll 62 is a rubber roll including the rubber portion 62ab. The heat sink 64 is attached to the press roll 62. The support roll 61 and the press roll 62 rotate with the non-coated portion 12a interposed therebetween, and thus, the non-coated portion 12a is stretched. At this time, the rubber portion 62ab repeats compressive deformation, and thus, the press roll 62 generates heat. The heat generated by the press roll 62 is transferred to the heat sink 64, and the heat is emitted to the air AR from the heat sink 64. Thus, the press roll 62 is cooled and a temperature rise of the press roll 62 is suppressed. Therefore, in manufacturing an electrode, a temperature rise of the electrode sheet 10 can be suppressed, and variation in stretching of the non-coated portion 12a can be reduced.

In the preferred embodiment described above, the non-coated portions 12a are arranged at the both ends of the electrode sheet 10 in the width direction. The electrode active material layer 14 is formed between the non-coated portions 12a arranged at the both ends of the electrode sheet 10 in the width direction. The press rolls 62 are arranged over the non-coated portions 12a arranged at the both ends. Thus, in a case where the electrode sheet 10 includes the non-coated portions 12a at the both ends in the width direction, each of the non-coated portions 12a can be stretched.

In the preferred embodiment described above, each of the press rolls 62L and 62R includes the heat sink 64. Thus, in a case where the non-coated portions 12a are arranged at the both ends of the electrode sheet 10 in the width direction, heat is emitted from each of the heat sinks 64. Therefore, in the case where the non-coated portions 12a are arranged at the both ends of the electrode sheet 10 in the width direction, the press rolls 62 can be more efficiently cooled.

In the preferred embodiment described above, the support roll 61 includes the shaft portion 61aa and the rubber portion 61ab. Therefore, the support roll 61 is a rubber roll. In this preferred embodiment, each of the rolls that stretch the non-coated portions 12a of the electrode sheet 10 with the non-coated portions 12a interposed therebetween is a rubber roll, heat can be emitted by the heat sink 64.

In the preferred embodiment described above, the press roll 62 is a rubber roll including the shaft portion 62aa and the rubber portion 62ab. The heat sink 64 is attached to the shaft portion 62aa and the rubber portion 62ab. Herein, the shaft portion 62aa is made of metal, and thus, has a relatively high heat conductivity. Therefore, a part of the heat generated from the rubber portion 62ab is also transferred to the shaft portion 62aa. The heat transferred to the shaft portion 62aa is also emitted from the heat sink 64. Therefore, with the heat sink 64 attached to the shaft portion 62aa made of metal, the heat generated by the press roll 62 is more easily transferred to the heat sink 64, as compared to a case where the heat sink 64 is attached only to the rubber portion 62ab. Therefore, the press roll 62 can be more efficiently cooled.

In the preferred embodiment described above, the heat conduction sheet 63 is arranged between the press roll 62 and the heat sink 64. With the heat conduction sheet 63 arranged between the press roll 62 and the heat sink 64, a gap is relatively less likely to be generated therebetween. Thus, a structure in which the heat generated from the press roll 62 can be relatively easily transferred to the heat sink 64 is provided. Therefore, the press roll 62 can be more efficiently cooled.

In the preferred embodiment described above, the electrode sheet manufacturing device 1 includes the air blowing device 66 that blows air to the heat sink 64. Air is blown to the heat sink 64, so that heat exchange with air surrounding the heat sink 64 is promoted more. Therefore, the press roll 62 can be more efficiently cooled.

In the preferred embodiment described above, the cover 65 covers a portion of the heat sink 64 and a portion of the press roll 62. The cover 65 includes the inflow port 65a, the air passage 65b, and the outflow port 65c. Therefore, the air blown from the air blowing device 66 passes through the air passage 65b and flows out from the outflow port 65c. Thus, a flow of air passing around the heat sink 64 is stabilized in a direction from the inflow port 65a to the outflow port 65c. Therefore, after the heat is emitted from the heat sink 64, air supplied from the air blowing device 66 easily flows out from the outflow port 65c. Therefore, a temperature rise of the air AR inside the cover 65 is suppressed. Thus, an effect of cooling by the heat sink 64 can be enhanced.

In the preferred embodiment described above, the suction device 67 is connected to the outflow port 65c. The suction device 67 sucks the air AR inside the cover 65. Therefore, the air AR to which heat is emitted from the heat sink 64 can more easily flow out from the outflow port 65c. Therefore, the effect of cooling by the heat sink 64 can be enhanced.

In the preferred embodiment described above, the air suction amount of the suction device 67 is set to be larger than the air blowing amount of the air blowing device 66. For example, when the air suction amount of the suction device 67 is smaller than the air blowing amount of the air blowing device 66, there is a probability that the air AR stays inside the cover 65. At this time, the air AR to which heat is emitted from the heat sink 64 does not flow out from the outflow port 65c, and a temperature inside the cover 65 rises. Therefore, the effect of cooling by the heat sink 64 is reduced. However, as in the preferred embodiment, the air suction amount of the suction device 67 is larger than the air blowing amount of the air blowing device 66, so that the air AR inside the cover 65 is less likely to stay. Thus, a temperature rise of the air AR inside the cover 65 can be suppressed. Therefore, the effect of cooling by the heat sink 64 can be increased.

The invention disclosed herein has been described above in various forms. However, the preferred embodiment described above or the like shall not limit the present invention, unless specifically stated otherwise. Various changes can be made to the preferred embodiment of the invention disclosed herein, and each of components and processes described herein can be omitted as appropriate or can be combined with another one or other ones of the components and the processes as appropriate, unless a particular problem occurs.

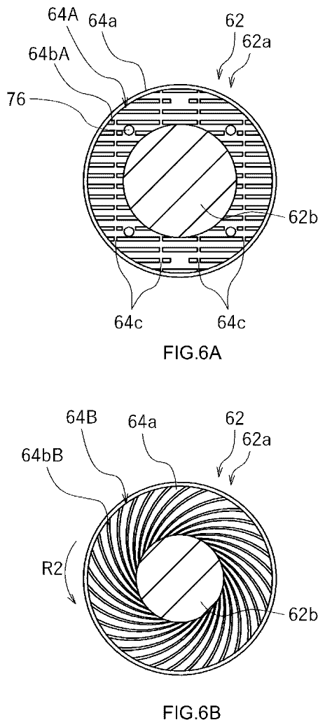

In this preferred embodiment, as the raised portion 64b of the heat sink 64, multiple plate-like members that extend in one direction when viewed from the shaft direction of the press roll 62 are provided, but the raised portion 64b is not limited thereto. FIG. 6A and FIG. 6B are views illustrating modified examples of the heat sink 64. Similar to FIG. 5, FIG. 6A and FIG. 6B illustrate heat sinks 64A and 64B when viewed from the cross section taken along the line A-A of FIG. 4, respectively. However, in FIG. 6A and FIG. 6B, illustration of other components than the press roll 62 and the heat sinks 64A and 64B is omitted. As illustrated in FIG. 6A, in the heat sink 64A, a slit 64c is formed so as to extend in an approximately perpendicular direction to a direction in which a raised portion 64bA extends. Thus, it is suppressed that air to which heat is emitted from the heat sink 64 is interposed between the raised portions 64b and stays therebetween. As illustrated in FIG. 6B, a raised portion 64bB of the heat sink 64B extends from an inner side to an outer side in a radial direction of the heat sink 64B, when viewed from the shaft portion of the press roll 62. The raised portion 64bB is curved in the direction of the arrow R2. That is, the raised portion 64bB is curved in the rotation direction of the press roll 62. Thus, when the press roll 62 rotates, air around the raised portion 64bB passes between the raised portions 64bB and can easily flow out of the heat sink 64B in the radial direction of the heat sink 64B. Therefore, it is suppressed that air to which heat is emitted from the heat sink 64B stays around the heat sink 64B.

In the preferred embodiment described above, the heat sink 64 is attached only to the press roll 62, but is not limited thereto. The heat sink 64 may be attached to the support roll 61, in addition to the press roll 62.

As described above, the present specification includes disclosure set force in the following items.

First Item: An electrode sheet manufacturing device that manufactures an electrode sheet including a current collector formed of a long metal foil, a non-formed portion set in a preset position in the current collector in the width direction so as to extend in the length direction, and an electrode active material layer formed in a portion of the current collector excluding the non-formed portion, the electrode sheet manufacturing device including a conveyance device that conveys the electrode sheet along a preset conveyance path, a support roll that is arranged on the conveyance path and supports a first surface of the electrode sheet that is conveyed along the conveyance path in the width direction, a press roll arranged so as to be opposed to the support roll on a second surface of the electrode sheet, a driving device that presses the press roll to the support roll with the electrode sheet interposed therebetween, and a heat sink, in which the press roll is arranged such that the non-formed portion of the electrode sheet is interposed between the support roll and the press roll, and the press roll is a rubber roll at least an outer peripheral surface of which is formed of rubber, and the heat sink is attached to an end portion of the press roll in a shaft direction.

Second Item: The electrode sheet manufacturing device according to the first item, in which, in the electrode sheet, the non-formed portion is arranged at each of both ends thereof in the width direction and the electrode active material layer is arranged between the non-formed portions arranged at the both ends in the width direction, and the press roll is arranged over each of the non-formed portions arranged at the both ends.

Third Item: The electrode sheet manufacturing device according to the second item, in which each of the press rolls arranged at the both ends includes the heat sink.

Fourth Item: The electrode sheet manufacturing device according to any one of the first to third items, in which the support roll is a rubber roll including a shaft portion made of metal and rubber arranged so as to cover at least an outer peripheral surface of the shaft portion.

Fifth Item: The electrode sheet manufacturing device according to any one of the first to fourth items, in which the press roll is a rubber roll including a shaft portion made of metal and rubber arranged to cover at least an outer peripheral surface of the shaft portion, and the heat sink is attached to the rubber and the shaft portion.

Sixth Item: The electrode sheet manufacturing device according to any one of the first to fifth items, further including a heat conduction sheet arranged between the press roll and the heat sink.

Seventh Item: The electrode sheet manufacturing device according to any one of the first to sixth items, further including an air blowing device that blows air to the heat sink.

Eighth Item: The electrode sheet manufacturing device according to the seventh item, further including a cover that covers a portion of the heat sink and a portion of the press roll, in which the cover includes an inflow port that is opened to the heat sink and to which the air blowing device is attached, an air passage that is connected to the inflow port and extends in a circumferential direction of the press roll, and an outflow port connected to the air passage and opened downstream of the inflow port in a predetermined rotation direction of the press roll.

Ninth Item: The electrode sheet manufacturing device according to the eighth item, further including a suction device that is connected to the outflow port and sucks air inside the cover.

Tenth Item: The electrode sheet manufacturing device according to the ninth item, in which an air suction amount of the suction device is larger than an air blowing amount of the air blowing device.

What is claimed is:

1. An electrode sheet manufacturing device that manufactures an electrode sheet including a current collector formed of a long metal foil, a non-formed portion set in a preset position in the current collector in the width direction so as to extend in the length direction, and an electrode active material layer formed in a portion of the current collector excluding the non-formed portion, the electrode sheet manufacturing device comprising:
a conveyance device that conveys the electrode sheet along a preset conveyance path;
a support roll that is arranged on the conveyance path and supports a first surface of the electrode sheet that is conveyed along the conveyance path in the width direction;
a press roll arranged so as to be opposed to the support roll on a second surface of the electrode sheet;
a driving device that presses the press roll to the support roll with the electrode sheet interposed therebetween; and
a heat sink,
wherein
the press roll is arranged such that the non-formed portion of the electrode sheet is interposed between the support roll and the press roll, and
the press roll is a rubber roll at least an outer peripheral surface of which is formed of rubber, and
the heat sink is attached to an end portion of the press roll in a shaft direction.

2. The electrode sheet manufacturing device according to claim 1, wherein
in the electrode sheet, the non-formed portion is arranged at each of both ends thereof in the width direction and the electrode active material layer is arranged between the non-formed portions arranged at the both ends in the width direction, and
the press roll is arranged over each of the non-formed portions arranged at the both ends.

3. The electrode sheet manufacturing device according to claim 2, wherein
each of the press rolls arranged at the both ends includes the heat sink.

4. The electrode sheet manufacturing device according to claim 1, wherein
the support roll is a rubber roll including a shaft portion made of metal and rubber arranged so as to cover at least an outer peripheral surface of the shaft portion.

5. The electrode sheet manufacturing device according to claim 1, wherein
the press roll is a rubber roll including a shaft portion made of metal and rubber arranged so as to cover at least an outer peripheral surface of the shaft portion, and
the heat sink is attached to the rubber and the shaft portion.

6. The electrode sheet manufacturing device according to claim 1, further comprising:
a heat conduction sheet arranged between the press roll and the heat sink.

7. The electrode sheet manufacturing device according to claim 1, further comprising:
an air blowing device that blows air to the heat sink.

8. The electrode sheet manufacturing device according to claim 7, further comprising:
a cover that covers a portion of the heat sink and a portion of the press roll,
wherein
the cover includes
an inflow port that is opened to the heat sink and to which the air blowing device is attached,
an air passage that is connected to the inflow port and extends in a circumferential direction of the press roll, and
an outflow port connected to the air passage and opened downstream of the inflow port in a predetermined rotation direction of the press roll.

9. The electrode sheet manufacturing device according to claim 8, further comprising:
a suction device that is connected to the outflow port and sucks air inside the cover.

10. The electrode sheet manufacturing device according to claim 9, wherein
an air suction amount of the suction device is larger than an air blowing amount of the air blowing device.
